(19) United States
(12) Patent Application Publication
(10) Pub. No.: US 2011/0049403 A1
(43) Pub. Date: Mar. 3, 2011

(54) Electromagnetic water supply valve

(76) Inventor: Gwan Ho Ro, Seoul (KR)

(21) Appl. No.: 12/805,966

(22) Filed: Aug. 26, 2010

(30) Foreign Application Priority Data
Aug. 28, 2009 (KR) 2009-80325

(51) Int. Cl. F16K 31/02

(52) U.S. Cl. 251/129.01

(57) ABSTRACT

A power-saving electromagnetic water supply valve includes a valve body, an electromagnet unit, and a first valve defining therein first and second water passages, the second water passage being opened and closed by a second valve. The first valve partitions the upper section of a chamber to form a pressure chamber, is attached to and detached from a valve seat of the chamber, and maintains a closed circuit state by the pressure of water. The water inlet and the pressure chamber of the valve body are connected directly to each other, thereby defining a common space. The water inlet and the pressure chamber are separated from each other by the base element when a filter retracts into the water inlet. A portion of water introduced toward the water inlet is supplied into the pressure chamber via the filter and the first water passage of the base element.

### CROSS REFERENCE TO RELATED APPLICATION

The present application claims priority from Korean Patent Application Number 10-2009-80325 filed on Aug. 28, 2009, the entire contents of which application are incorporated herein for all purposes by this reference.

### BACKGROUND OF THE INVENTION

1. Field of the Invention

The present invention relates to a power-saving electromagnetic water supply valve that maintains a closed circuit state using supply water pressure and, more particularly, to an electromagnetic water supply valve having a stable structure in which water passages for maintaining the closed circuit state can be easily managed.

2. Description of Related Art

Various types of valves that control a flow of supply water using an electromagnet have been developed up to the present. These types of water supply valves (hereinafter, referred to “electromagnetic water supply valves”) are typically used in a variety of devices, to which an automatic water supply device is applied, for example, a washing machine, a refrigerator, a beverage vending machine, a dish washer, and a boiler. That is, the water supply valves are used in a variety of articles that require automatic water supply.

Such an electromagnetic water supply valve is installed in a terminal of a water supply system, such as a water supply pipe, or the water inlet side of an instrument to control the flow of supply water. Describing an example of the electromagnetic water supply valve, as shown in FIG. 1, the water supply valve includes a valve body 10 and an electromagnet unit 20.

The valve body 10 includes a water inlet 11, a water outlet 12, and a chamber 14 between the water inlet 11 and the water outlet 12. The water inlet 11 is connected with the chamber 14 via a connecting passage 11a, and a valve seat 13 is provided in the central portion of the chamber 14.

The electromagnet unit 20 drives a first valve 15 to be attached to and detached from the valve seat 13 inside the chamber 14, so that the chamber 14 and the water outlet 12 are connected to and separated from each other. The first valve 15 also partitions the inside of the chamber 14 into the upper and lower sections, such that a pressure chamber 14 is defined in the upper section.

In addition, the first valve 15 includes a diaphragm 15a and a diaphragm holder 15b. The first valve 15 also has a first water passage 17 in the peripheral portion thereof beyond the valve seat 13, and a second water passage 18 in the central portion thereof. The first water passage 17 connects the chamber 14 with a pressure chamber 16, and the second water passage 18 connects the pressure chamber 16 with the water outlet 12.

In the first and second water passages 17 and 18, the second water passage 18 is opened and closed by a second valve 23 on the lower end of a plunger 22 that is installed inside the electromagnet unit 20 under a downward elastic force from a spring 21. Here, the first water passage 17 has an inner diameter smaller than that of the second water passage 18, and controls a flow of supply water following the opening and closing of the second water passage 18.

Describing it in more detail, in the suspension of water supply (i.e. when power is not supplied to the electromagnet unit 20), the plunger 22 is brought into close contact with the valve seat 13 under its weight and the downward elastic force of the spring 21 and, at the same time, supply water supplied from the water inlet 11 pushes the first valve 15 upward instantaneously in the initial stage. This is because the elastic force of the spring 21, which presses the plunger 22, is smaller than supply water pressure.

However, the first valve 15, which is pushed upward, is directly closed by the supply water pressure. That is, right after water pressure is applied to the underside of the first valve 15, a portion of supply water is introduced into the pressure chamber 16 through the first water passage 17 in the first valve 15. The supply water introduced in this fashion applies a certain pressing force to the upper surface of the first valve 15 to bring the first valve 15 into close contact with the valve seat 13, thereby maintaining a closed circuit state. In this fashion, it is possible to achieve the closed circuit state that stops water supply without consuming electrical power.

In addition, when power is applied to the electromagnet unit 20, the plunger 22 of the electromagnet unit 20 is pushed upward, thereby opening the second water passage 18 of the first valve 15, which was closed by the second valve 23. At this time, the water in the pressure chamber 16 is caused to flow instantaneously toward the water outlet 12 under the atmospheric pressure through the second water passage 18, thereby dropping the pressure inside the pressure chamber 16 to the same as the atmospheric pressure. The force acting on the first valve 15 is released, so that the pressure of water supplied from the water inlet 11 causes the first valve 15 to drop to the upper surface of the valve seat 10. At the same time, a supply water passage passing through the water inlet 11, the chamber 14, and the water outlet 12 of the valve body 10 is maintained in the open circuit state, thereby achieving the intended water supply state.

In order to remove impurities from supply water, which passes through the power-saving electromagnetic water supply valve as described above, a filter 24 is necessarily provided adjacent to the water inlet 11. While the filter 24 prevents the first water passage 17 and the second water passage 18 from being clogged by the cohesion of impurities, small particles of the filter 24 significantly reduce the flow rate compared to an amount of introduced water. In addition, impurities accumulated in the filter increase resistance and thus water is not properly supplied.

Therefore, water supply valves designed to ensure the flow rate of supply water and prevent the water passages from being clogged by impurities have recently been proposed.

In an example, Korean Utility Model Registration No. 379895, titled “SOLENOID VALVE,” can be referred to. In this valve, a tubular filter penetrating in the direction in which supply water flows is installed inside the inlet and spaced apart from the main wall, and an introduction passage connecting the inlet side and the space provided above the diaphragm is formed on the main wall of the inlet connecting passage of the valve body such that it radially crosses the direction of supply water. This configuration allows the device to filter water on which pressure is acting and to ensure a proper flow rate.

However, this valve fails to efficiently introduce water on which pressure is acting, since the introduction passage in the valve body is arranged perpendicular to the direction in which water flows. In addition, a mold has a complicated structure. Furthermore, there is a drawback in that a troublesome operation of separating the valve body, i.e. the electromagnet unit, is required in the case of maintenance, such as cleaning inside the introduction passage after continued use.

The information disclosed in this Background of the Invention section is only for the enhancement of understanding of the background of the invention, and should not be taken as an acknowledgment or any form of suggestion that this information forms a prior art that would already be known to a person skilled in the art.

### BRIEF SUMMARY OF THE INVENTION

Various aspects of the present invention provide an electromagnetic water supply valve that achieves a simple structure and easy maintenance by providing a passage of water on which pressure is acting in a position adjacent to a filter, instead of being provided in a valve body.

Also provided is an electromagnetic water supply valve that allows water on which pressure is acting to be efficiently introduced by providing a water passage in the direction parallel to the direction in which water is supplied.

In an aspect of the present invention, the power-saving electromagnetic water supply valve maintains a closed circuit state by the pressure of water introduced thereto. The power-saving electromagnetic water supply valve includes a valve body including a water inlet, a water outlet, and a chamber between the water inlet and the water outlet, the water inlet having a filter therein, the chamber having a valve seat therein; an electromagnet unit; and a first valve defining therein a first water passage and a second water passage, the second water passage being opened and closed by a second valve. The first valve partitions the upper section of the chamber to form a pressure chamber, is attached to and detached from the valve seat to control water supply, and maintains the closed circuit state by the pressure of water introduced into the pressure chamber. The water inlet and the pressure chamber of the valve body are connected directly to each other, thereby defining a common space. The filter includes a cap-like net and a base element, the water inlet and the pressure chamber of the common space separated from each other by the base element when the filter retracts into the water inlet. The first water passage of the filter connects between the water inlet and the pressure chamber. A portion of water introduced toward the water inlet is supplied into the pressure chamber via the filter and the first water passage of the base element. Accordingly, the electromagnetic water supply valve has a stable structure in which water passages for maintaining the closed circuit state can be easily managed.

As set forth above, in the electromagnetic water supply valve, the filter freely retracts into and protrudes from the inside of the water inlet, and the water passage, for water on which pressure is acting, is formed in the filter. The structure is simplified, and the water passage can be conveniently maintained by separating the filter from the inside of the water inlet without disassembling the valve body. Thereby, maintenance of the water passage can be done simply and easily.

In addition, the electromagnetic water supply valve can efficiently introduce water on which pressure is acting, and be operated stably, since the water passage is formed in the direction parallel to a direction in which water is supplied.

The methods and apparatuses of the present invention have other features and advantages which will be apparent from, or are set forth in more detail in the accompanying drawings, which are incorporated herein, and in the following Detailed Description of the Invention, which together serve to explain certain principles of the present invention.

### BRIEF DESCRIPTION OF THE DRAWINGS

FIG. 1 is a cross-sectional view showing the configuration of a general electromagnetic water supply valve;

FIG. 2 is a cross-sectional view showing the configuration of an electromagnetic water supply valve according to an exemplary embodiment of the invention;

FIG. 3 is a cross-sectional view taken along line A-A in FIG. 2.

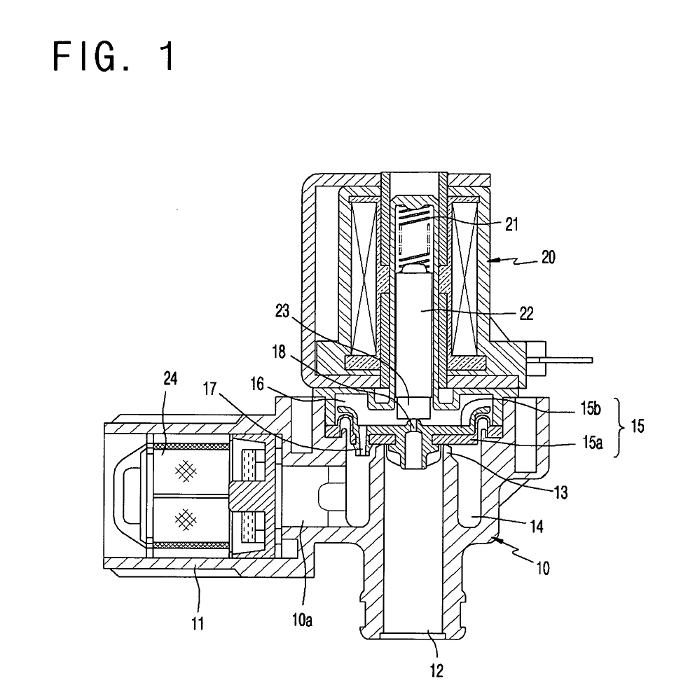

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments that may be included within the spirit and scope of the invention as defined by the appended claims.

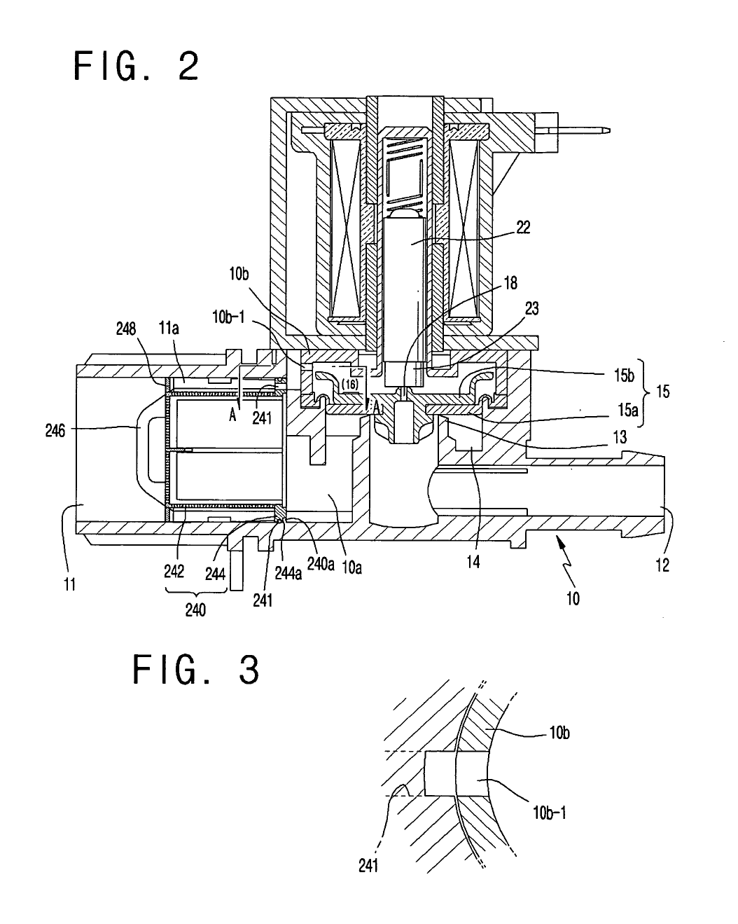

FIGS. 2 and 3 show an electromagnetic water supply valve according to an exemplary embodiment of the invention in detail.

The electromagnetic water supply valve of this embodiment generally includes a valve body 10 and an electromagnet unit 20, which is detachably coupled to the upper portion of the valve body 10.

The valve body 10 defines therein a water inlet 11, a water outlet 12, and a chamber 14 between the water inlet 11 and the water outlet 12. The chamber 14 has a valve seat 13 in the central portion thereof, and is connected with the water inlet 11 and the water outlet 12 via a connecting passage 10a.

In addition, a first valve 15 is interposed between the valve body 10 and the electromagnet unit 20 fixedly assembled to the upper portion of the valve body 10, and is fixed via a separate upper cap 10b. The first valve 15 is attached to and detached from the upper surface of the valve seat 13 under the pressure of supply water. The first valve 15 partitions the inside of the chamber 14 into the upper and lower sections, thereby defining a pressure chamber 16 in the upper section of the inside of the chamber 14.

In addition, the first valve 15 includes a diaphragm 15a and a diaphragm holder 15b in the lower and upper portions thereof. A second water passage 18 is provided in the central portion of the first valve 15, thereby forming a passage connecting between the pressure chamber 16 and the water outlet 12.

Inside the electromagnet unit 20, a plunger 22 is elastically forced downward by a spring 21 that has a very small elastic modulus compared to the pressure of supply water. The elastic modulus of the spring 21 is set small as above in order to operate the electromagnet using a small magnetic force, thereby miniaturizing the volume of an electromagnet while minimizing power consumption.

In addition, a second valve 23 is provided on the lower end of the plunger 22. The second valve 23 opens and closes the second water passage 18 defined in the central portion of the first valve 15.

The above-described power-saving water supply valve regards a general water supply valve, and the key concept of the invention is the innovation of a filter and a water passage structure adjacent to the inlet 11 of the water supply valve.

First, according to an exemplary embodiment of the invention, the water inlet 11 and the pressure chamber 16 provided in the valve body 10 are connected directly to each other without need for the connecting passage 10a, unlike the related art, thereby forming one common space.

In addition, a filter 240 is configured to freely retract into and protrude from the inside of the water inlet 11, and includes a cap-like net 242 and a base element 244. The net 242 is spaced apart from the inner wall of the inlet 11, and is provided with an inlet passage 11a that introduces a portion of supply water toward the pressure chamber 16 through a first water passage 241, which will be described later, so that the portion of supply water is parallel to the direction in which supply water flows. The net 242 has a knob 246 on the leading end thereof and a stopper wall 248 on the circumference thereof, the stopper wall 248 stopping the leading end of the inlet passage 11a. With this configuration, when supply water (i.e. water under pressure) is introduced into the inlet passage 11a, impurities are filtered through the net 242, and the supply water is introduced toward the pressure chamber 16 through a passage 10b-1, provided in the upper cap 10b.

In addition, when the filter 240 having the above-described configuration retracts into the water inlet 11, the water inlet 11 and the pressure chamber 16, which form one common space, are separated from each other by the base element 244.

The first water passage 241 is provided in the base element 244 of the filter 240 such that it connects the water inlet 11 and the pressure chamber 16 to introduce a portion of supply water toward the pressure chamber 16.

The base element 244 of the filter 240 is provided with a positioning element 244a that is coupled in a male-female relationship with a protrusion 240a provided on the inner wall of the water inlet 11, such that the first water passage 241 of the filter 240 is aligned in position. Thereby, the filter 240 can be assembled stably and correctly.

The filter 240 also has a closing element 241 provided on the sidewall of the base element 244. When the closing element 241 is completely inserted into the water inlet 11, it comes into close contact with the inner wall of the water inlet 11, thereby providing a water seal.

The foregoing descriptions of specific exemplary embodiments of the present invention have been presented for the purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A power-saving electromagnetic water supply valve comprising:
a valve body including a water inlet, a water outlet, and a chamber between the water inlet and the water outlet, the water inlet having a filter therein, the chamber having a valve seat therein;
an electromagnet unit; and
a first valve defining therein a first water passage and a second water passage, the second water passage being opened and closed by a second valve, wherein the first valve partitions an upper section of the chamber to form a pressure chamber, is attached to and detached from the valve seat to control water supply, and maintains a closed circuit state by a pressure of water introduced into the pressure chamber,
wherein the water inlet and the pressure chamber of the valve body are connected directly to each other, thereby defining a common space,
wherein the filter includes a cap-like net and a base element, the water inlet and the pressure chamber of the common space separated from each other by the base element when the filter retracts into the water inlet, and
wherein the first water passage of the filter connects between the water inlet and the pressure chamber,
whereby a portion of water introduced toward the water inlet is supplied into the pressure chamber via the filter and the first water passage of the base element.

2. The power-saving electromagnetic water supply valve according to claim 1, wherein the filter further includes a positioning element, the positioning element coupled in a male-female relationship with a protrusion on an inner wall of the water inlet of the valve body in order to ensure position alignment.
